(19) United States
(12) Patent Application Publication
(10) Pub. No.: US 2005/0151629 A1
(43) Pub. Date: Jul. 14, 2005

(54) Anti-theft system for a motor vehicle

(75) Inventor: Robert Simoneau, Chambly (CA)

Correspondence Address: BIRCH STEWART KOLASCH & BIRCH, PO BOX 747, FALLS CHURCH, VA, 22040-0747, US

(73) Assignee: C-Chip Technologies Corporation

(21) Appl. No.: 11/072,314

(22) Filed: Mar. 7, 2005

Related U.S. Application Data
(63) Continuation of application No. 10/250,762, filed on Oct. 9, 2003, now abandoned.

(30) Foreign Application Priority Data
Jan. 9, 2001 (CA) 2,330,514

(51) Int. Cl. B60R 25/10

(52) U.S. Cl. 340/426.11; 340/426.13; 307/10.2; 340/5.72

(57) ABSTRACT

The system (10) comprises a control unit (20) used for selectively arming and disarming the system (10), and at least one actuator unit (30) which is remotely located within the vehicle with reference to the control unit (20). The actuator unit (30) comprises an actuator (32) capable of selectively enabling and disabling operation of a component of the vehicle required for normal operation thereof. Command signals are transmitted from the control unit (20) to the actuator unit (30) through air or in existing wires of the vehicle, thereby not requiring external wiring between them. The system (10) may further comprise a towing sensor unit (40) and an alarm unit (50). The system (10) reduces difficulties and disadvantages of the prior art by providing an anti-theft system where various units can be easily hidden throughout the vehicle.

The present invention relates to an anti-theft system for use in a motor vehicle and a method of using an anti-theft system. More particularly, the present invention relates to an anti-theft system comprising at least one actuator unit for selectively enabling and disabling operation of a component of the vehicle required for the vehicle to function normally.

In general, an anti-theft system consists of an assembly of various electronic parts, mostly in the form of pre-assembled units, which are connected to each other using an external wiring, more particularly wires dedicated for the communication between the units. The communication can be made using command signals or in the form of power supplied to a given unit for activating or disabling it. Some systems are also provided as a single unit in order to avoid or reduce the required wiring.

Many anti-theft systems rely on audio and visual signals in an attempt to deter the theft of or in vehicles. While these systems may provide some degree of dissuasion and prevent theft, there are no anti-theft systems in a strict sense unless they are provided with an actuator, mechanical or purely electronic, capable of selectively enabling and disabling one or more components of the vehicle. Ideally, this or these components should prevent the vehicle to completely operate when disabled. Examples of such components are, but not limited to: on-board computers, transmissions, fuel pumps, ignition coils, starters, ignition switches, batteries or any other electrically-powered devices required for the proper functioning of the vehicle.

An anti-theft system typically comprises a control unit mounted somewhere in the vehicle. The control unit receives instructions, generally from the authorized driver, in the form of RF signals emitted by a small remote control unit attached to a key ring. Authentication of the authorized driver can also be achieved through numerous other ways, including a keyboard, a magnetic key or simply by pressing a hidden button. The control unit manages the functions of the system, including arming and disarming it. Once disarmed, the system sends an appropriate signal to the actuator unit or units for allowing normal operation of the vehicle.

While on-board computers, also referred to as electronic control units (ECU), were widely used in prior art as the disabled components when anti-theft systems are armed, completely satisfactory installations of conventional anti-theft systems were not always possible or achieved. One problem is that an on-board computer or wires coming out therefrom can be found easily, as they are usually under the dashboard. Once they are found, wires used to prevent the computer from operating can be bypassed easily by a skilled thief. For this reason, relying solely on disabling the on-board computer is not always sufficient. Other components may then be disabled. However, to do so, the other components need to be connected to the control unit of the anti-theft system using wires. These wires have to be concealed for security reasons, which is often something difficult and tedious.

### SUMMARY

The present invention reduces the difficulties and disadvantages of the prior art by providing an anti-theft system where the various units can be hidden throughout the vehicle and communicate with the control unit of the system without the need of external wiring.

Preferably, the system comprises a control unit to be mounted on the vehicle. The control unit comprises means for selectively arming and disarming the system. At least one actuator unit is provided. The actuator unit comprises an actuator capable of selectively enabling and disabling operation of a component of the vehicle required for normal operation thereof. The system is characterized in that the control unit comprises means for communicating coded command signals to the actuator unit without external wiring, the coded command signals being indicative whether normal operation of the component of the vehicle is to be enabled or disabled. The system is also characterized in that the actuator unit is remotely located within the vehicle with reference to the control unit and comprises means for receiving the coded command signals and for instructing the actuator to operate in response thereof.

This system, and the corresponding method, are well adapted to be used as O.E.M. equipment or after-market equipment on vehicles. Since no external wiring is required, the installation is simplified, thus being less costly. The system can also be interfaced with an existing or another alarm system provided on the vehicle. Moreover, this anti-theft system increases the difficulty of stealing a vehicle since the various units can be hidden throughout the vehicle, with the possible use of decoy units.

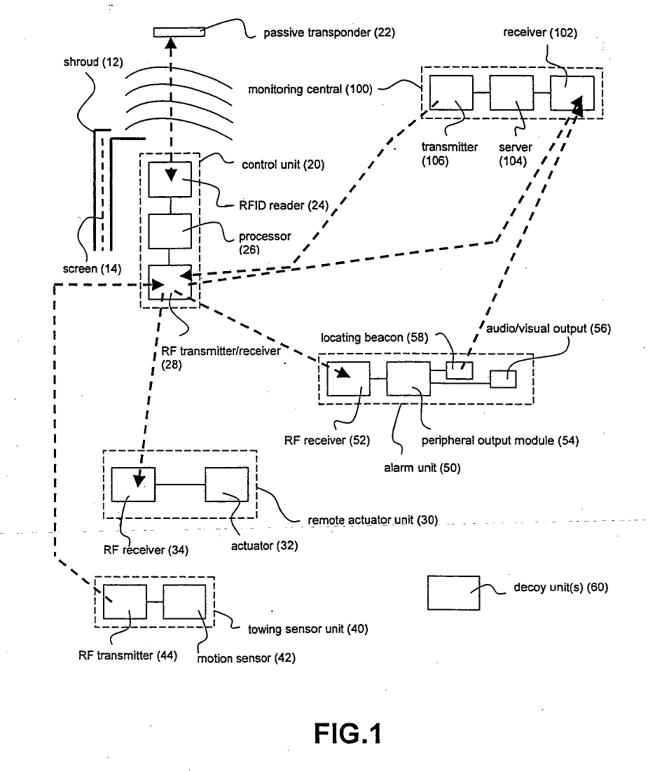

These and other aspects and advantages of the present invention are described in or apparent from the following detailed description of a preferred embodiment, made in conjunction with the accompanying sole FIGURE, namely FIG. 1, which is a block diagram schematically showing a preferred and possible embodiment of the anti-theft system.

The following is a list of reference numerals, along with the names of the corresponding components, which are used in the accompanying FIGURE and in the detailed description:

10 system

12 shroud

14 conductive screen

20 control unit

22 portable passive transponder (RFID transponder)

24 RFID reader

26 processor

28 RF transmitter/receiver

30 remote actuator unit

32 actuator

34 RF receiver

40 towing sensor unit

42 motion sensor

44 RF transmitter

50 alarm unit

52 RF receiver

54 peripheral output module

56 audio/visual output

58 locating beacon

60 decoy unit

100 monitoring central

102 receiver

104 server

106 transmitter

Referring to FIG. 1, there is shown an example of an anti-theft system (10) according to a preferred embodiment. This system (10) is for use in a motor vehicle, such as an automobile, a truck, a boat or any other kind of vehicle where it may be useful.

The system (10) comprises a control unit (20) which is preferably designed to fit in a small casing. This control unit (20) is to be mounted on the vehicle, preferably under the dashboard or the steering column. Power is continuously supplied to the control unit (20) using an existing wire or one provided for that purpose. The control unit (20) comprises means for selectively arming and disarming the system (10). These means can have many forms and include a remote control, a keyboard, an electronic key, a biometric sensor, etc.

For greater protection, the control unit (20), or parts of the vehicle around it, may be covered by a protective shroud (12). The shroud (12) includes a densely-designed internal screen (14) set inside an insulating material. The screen (14) consists of conductive wires in which signal or tension is applied. The shroud (12) operates with a corresponding electronic detection circuit which may be integrated to the control unit (20) or simply connected to it. The shroud (12) is designed to detect an attempt to illicitly reach the control unit (20) by inserting an object, for instance a screwdriver, to break the parts surrounding it. The insertion of the object would cause one or several wires of the screen (14) to be cut, thereby changing the response of the wire to the applied signal or tension. This situation would cause an alarm event to be generated.

In the preferred embodiment, the means for selectively arming and disarming the system (10) comprise a radio-frequency identification (RFID) transponder (22) and a RFID reader (24). The RFID transponder (22) is preferably a portable passive transponder in the form of a small key fob which can be attached to a key ring with the conventional key or keys of the vehicle. The RFID reader (24) is provided in the control unit (20). It can also be located outside the main casing of the control unit (20) and connected to it by a wire. The RFID reader (24) continuously generates a small interrogation field, which field could be advantageously limited to the vicinity of the steering column. The RFID transponder (22) includes an internal circuitry designed to be energized by the interrogation field of the RFID reader (24) and accordingly, is not provided with a battery. When energized, the RFID transponder (22) transmits a low-level response signal unique to the individual RFID transponder (22), which response signal was programmed at the point of manufacture. For added security, the RFID transponder (22) and the RFID reader (24) may be capable of exchanging a rolling code. They could also be programmable using coded RF energy emanating from a coding module at a service center.

The control unit (20) further comprises a processor (26) to which data received by the RFID reader (24) from a RFID transponder (22) is sent for analysis. The processor (26) is associated with a memory in which the operating instructions and data corresponding to valid transponders is stored. The data can include an identification or serial number, a security number, etc. Authentication of an authorized driver is then achieved by possession of a valid RFID transponder (22). The advantage of this method is that disarming the anti-theft system (10) could be made without direct intervention of the driver if, for instance, the RFID reader (24) is placed near the ignition switch. The system (10) can also be designed to verify the presence of the RFID transponder (22) after the motor of the vehicle is turned off and to arm itself once the RFID transponder (22) is no longer within the range of the RFID reader (24). Of course, other methods of arming the system (10) are possible. It should be noted that disarming the system (10) means allowing normal operation of the vehicle and not issuing an alarm signal. The system (10) is preferably connected at all times and remains at least partially activated even when disarmed.

The processor (26) is connected to a RF transmitter/receiver (28). It should be noted that some embodiments of the anti-theft system (10) may be designed simply with a RF transmitter, thus a device not being capable of receiving signals. In the preferred embodiment, the device is capable of both transmitting and receiving RF signals. The expression [symbol] RF transmitter/receiver [symbol] also includes the case where the two functions are achieved by two separate devices connected to the processor (26). The RF transmitter/receiver (28) preferably uses a low-frequency to establish communication with other units of the anti-theft system (10). The transmission can be either through air or the existing automotive wiring. Numerous frequencies are possible, depending on the chipsets, the available components and the target sale price. When transmitting through air, example of frequencies are 128 kHz and 472 MHz, the latter having a longer range and requiring less power. It is however more expensive. Similarly, the communication with all units may be bi-directional if proper equipment is provided.

The anti-theft system (10) further comprises at least one actuator unit (30). The actuator unit (30) is to be mounted on the vehicle and comprises an actuator (32) capable of selectively enabling and disabling operation of a component of the vehicle required for normal operation thereof. It is preferably connected to a component which can prevent the vehicle from completely operating when disabled, although it could be designed to allow the vehicle to operate only partially, for instance preventing the vehicle from operating above a low-speed limit or in a forward direction. Other scenarios are possible as well, such as allowing pulsed operation. The actuator (32) may comprise mechanical parts or only electronic parts which are designed, for instance, to prevent power from reaching a vital portion of the corresponding component.

The components to which the actuator or actuators (32) can be interfaced include the transmission, the fuel pump, the ignition coil, the ignition switch, the starter, the battery, the on-board computer (ECU) and any other electrically-powered device required for the proper functioning of the vehicle. The components may also include a static or a non-electrically powered part. For instance, the actuator (32) may comprise a servo-valve located on the fuel line or the fresh air supply of the motor. All these components may be designed to shut off or otherwise affect a component either progressively, suddenly or in a pulsed fashion.

The actuator unit (30) is remotely located within the vehicle with reference to the control unit (20), which means that there is no [symbol] physical [symbol] link between them. The actuator unit (30) comprises means (34) for receiving the coded command signals and for instructing the actuator (32) to operate in response thereof. These means are preferably comprising a RF receiver (34) designed to receive the coded command signals from the RF transmitter/receiver (28) of the control unit (20), either through air or the existing wires of the vehicle, and relay these signals to the actuator (32). Power is supplied to the actuator unit (30) preferably using a nearby power source or power supplied by the vehicle to the component on which the actuator (32) is acting. The actuator unit (30), and consequently its actuator (32), are preferably designed to draw a very lower power, at least in a standby mode. This would prevent the component from being affected by the presence of the actuating unit (30) when the latter draws power from it and from possibly triggering a warning signal from the on-board computer, which signal would typically result in a “check engine” warning light turning on. The actuating unit (30) preferably operates only at a change of state, for instance when the vehicle is started or turned off.

In use, the control unit (20) sends a command signal to the actuator unit (30) when the RFID transponder (22) was found to be a valid one for the corresponding vehicle. The RF transmitter/receiver (28) sends a coded signal, which means that the enabling or disabling signal is specific for the actuator unit (30) of a given vehicle. Once received by the RF receiver (34), a control circuit in the actuator unit (30) checks if the signal is a valid signal, and then instructs the actuator (32) to operate accordingly.

The anti-theft system (10) may further comprise a towing sensor unit (40) to detect an attempted theft of the vehicle by towing it. Although the towing sensor unit (40) is preferably hidden in the vehicle at a remote location with reference to the control unit (20), advantageously near the front or the rear of the vehicle since the amplitude of movement is greater at these locations, it is possible to provide the towing sensor unit (40) within the casing of the control unit (20). Several towing sensor units (40) preferably can be used in the same vehicle if desired. Each towing sensor unit (40) comprises a motion sensor (42) coupled to a RF transmitter (44). The motion sensor (42) can be mechanical or purely electronic, and preferably senses any change of position in all 3 planes. The RF transmitter (44) transmits a signal to the RF transmitter/receiver (28) of the control unit (20) to indicate that a change of position occurred. The processor (26) of the control unit (20) then determines whether the signal is indicative of an attempted theft or not. The towing sensor unit (40) continuously receives electric power from a local source or is provided with a battery.

The anti-theft system (10) preferably comprises an alarm unit (50), which unit may also be integrated in the casing of the control unit (20). The alarm unit (50) may have several embodiments, depending on whether a monitoring central (100) is used or not. More than one alarm unit (50) may be used in a vehicle and it could also be another anti-theft system. The alarm unit (50) is essentially used when an alarm event occurs, in which case it will carry out one or a plurality of actions. The alarm unit (50) is preferably also located at a remote location with reference to the control unit (20). It comprises a RF receiver (52) and a peripheral output module (54), the latter being used to control operation of the various devices in the alarm unit (50). The RF receiver (52) is used to relay coded command signals emitted from the control unit (20) through air or the existing wiring of the vehicle. One of the devices of the alarm unit (50) may be an audio/visual output (56) which allows the light of the vehicle and/or a siren to operate for providing an indication that an attempted theft occurred, and possibly an indication that the system (10) is being armed or disarmed. Since an audio/visual output (56) can only work temporally and has little effect on theft, the alarm unit (50) may be provided with means for establishing communication with a monitoring central (100) which may notify the owner and police authorities, and possibly track the vehicle.

The alarm unit (50) may further comprise a locating beacon (58) including a global positioning system (GPS) receiver or an equivalent to report the position of the vehicle using an integrated cellular phone or another suitable kind of RF emitter. The alarm unit (50) may then be used to communicate automatically with the receiver (102) of the monitoring central (100), and possibly with a tracking vehicle sent on the scene, to report the position of the corresponding vehicle and other details in case it is stolen. The monitoring central (100) includes one or more servers (104) to assist in managing the surveillance operations. Communication with the receiver (102) of the monitoring central (100) can be made at all times or intermittently, such as in case of an alarm or following a request from the monitoring central (100) or the tracking vehicle. Moreover, the cellular phone or the RF emitter may include a scalable power feature to facilitate the final positioning by the tracking vehicle. For instance, the transmission power may be shifted from 50 mW to 300 mW.

Optionally, the monitoring central (100) may be used to remotely disable one or more components of the vehicle, for instance by sending an appropriate signal from a transmitter (106) to the RF transmitter/receiver (28), or even directly to any other receiver of the system (10). The remote disabling of the vehicle could be made following instructions from police authorities in case of a chase. Ideally, the vehicle is stopped progressively.

The antenna of a GPS receiver needs to be located somewhere without overhead metallic parts. It is thus generally located in line with the front or rear windows. A thief, knowing the presence thereof, may try to block the antenna by placing a metallic cover or another kind of blocking object on the dashboard and the rear shelf. Accordingly, the anti-theft system (10) may be equipped with a detector of obstructing objects, which detector is connected to the control unit (20) for generating an alarm if an attempt to block the GPS signal is sensed. The detector may have many forms. One of them is to provide two parallelly-disposed induction coils with a circuit capable of sensing the disruption of the signal indicative that an object was laid above them. A low-frequency signal is applied to one of the coil, for instance 100 or 150 Hz, and the signal in the other coil is sensed. Other embodiments are possible as well.

Another possible embodiment is to provide the system (10) with the ability to analyze the signal received from the GPS receiver of the locating beacon (58), if any, and to determine the [symbol] signature [symbol] of the variation in the signal. The signal of the cellular phone, if any, may be analyzed as well. This would allow to know if, for example, a vehicle is being placed in a metallic container to be shipped elsewhere. The system (10) could then attempt to call the monitoring central (100) to report its last known position. Knowing the variation of the signal and the specific signatures of some situations allows the system (10) to make the difference between putting the vehicle in a container and parking the vehicle in an underground parking.

Advantageously, one or more decoy units (60) may be placed throughout the vehicle to frustrate intended theft and increasing the difficulty of stealing the vehicle. These decoy units (60) preferably have the same physical appearance as other units but are in fact empty boxes.

The system (10) can also be interfaced with an existing or another alarm system provided on the vehicle, for instance using an optical coupler or any other suitable kind of link.

As can be appreciated, the control unit (20) is capable of communicating coded command signals to the actuator unit (30) without external wiring, the coded command signals being indicative whether normal operation of the component of the vehicle is to be enabled or disabled.

The present invention is not limited to the described embodiment and encompasses any alternative embodiments within the limits defined by the claims.

1. An anti-theft system (10) for use in a motor vehicle, the system (10) comprising:
a control unit (20) to be mounted on the vehicle, the control unit (20) comprising means for selectively arming and disarming the system (10); and
at least one actuator unit (30) to be mounted on the vehicle, the actuator unit (30) comprising an actuator (32) capable of selectively enabling and disabling operation of a component of the vehicle required for normal operation thereof;
the system (10) being characterized in that:
the control unit (20) comprises means (28) for communicating command signals to the actuator unit (30) without external wiring, the command signals being indicative whether normal operation of the component of the vehicle is to be enabled or disabled; and
the actuator unit (30) is remotely located within the vehicle with reference to the control unit (20) and comprises means (34) for receiving the command signals and for instructing the actuator (32) to operate in response thereof.

2. An anti-theft system (10) according to claim 1, characterized in that the means for selectively arming and disarming the system (10) comprises a radio-frequency identification (RFID) reader (22) capable of generating a RF interrogation field and receiving a response signal from a portable RFID transponder (24), the RFID reader (22) being coupled to a processor (26) associated with a memory to verify whether the response signal is a valid signal or not.

3. An anti-theft system (10) according to claim 1, characterized in that the component of the vehicle is chosen from a group consisting of a transmission, a fuel pump, an ignition coil, an ignition switch, a starter, a battery, an on-board computer, a fuel line and a fresh air supply conduit of the motor.

4. An anti-theft system (10) according to claim 1, characterized in that the means for communicating command signals to the actuator unit (30) comprise a RF transmitter (28).

5. An anti-theft system (10) according to claim 4, characterized in that the RF transmitter (28) emits through air.

6. An anti-theft system (10) according to claim 4, characterized in that the RF transmitter (28) emits through an existing wire of the vehicle.

7. An anti-theft system (10) according to claim 1, characterized in that the means for receiving the command signals and for instructing the actuator (32) to operate in response thereof comprise a RF receiver (34).

8. An anti-theft system (10) according to claim 1, characterized in that it further comprises a towing sensor unit (40), the towing sensor unit (40) being provided with a motion sensor (42) generating a signal when sensing motion of the vehicle.

9. An anti-theft system (10) according to claim 8, characterized in that the towing sensor unit (40) is remotely located with reference to the control unit (20), the towing sensor unit (40) further comprising a RF transmitter (44) capable of sending a signal to the control unit (20) indicative that motion was sensed.

10. An anti-theft system (10) according to claim 1, characterized in that it further comprises an alarm unit (50) to report an alarm event.

11. An anti-theft system (10) according to claim 10, characterized in that the alarm unit (50) comprises means for establishing communication with a remote monitoring central.

12. An anti-theft system (10) according to claim 11, characterized in that it further comprises a locating beacon (58) to sense the position of the vehicle and means for transmitting the position of the vehicle to the remote monitoring central (100).

13. An anti-theft system (10) according to claim 12, characterized in that the locating beacon (58) comprises a global positioning system (GPS) receiver.

14. An anti-theft system (10) according to claim 12, characterized in that the means for transmitting the position of the vehicle comprise a RF emitter.

15. An anti-theft system (10) according to claim 13, characterized in that the RF emitter comprises a cellular phone.

16. An anti-theft system (10) according to claim 1, characterized in that it further comprises at least one decoy unit (60) to be mounted on the vehicle.

17. A method of using an anti-theft system (10) in a motor vehicle, the method comprising:
selectively arming and disarming the system (10) with a control unit (20) provided in the vehicle; and
selectively enabling and disabling operation of a component of the vehicle required for normal operation thereof with at least one actuator unit (30) provided in the vehicle, the actuator unit (30) comprising an actuator (32);
the method being characterized in that it comprises:
communicating command signals to the actuator unit (30) from the control unit (20) without external wiring, the command signals being indicative whether normal operation of the component of the vehicle is to be enabled or disabled and the actuator unit (30) being remotely located within the vehicle with reference to the control unit (20);
receiving the command signals at the actuator unit (30); and
instructing the actuator (32) to operate in response of the command signals.

18. A method according to claim 17, characterized in that selectively arming and disarming the system (10) comprises:
generating a RF interrogation field;
receiving a response signal from a portable RFID transponder (24); and
verifying whether the response signal is from a valid RFIF transponder (24) or not.

19. A method according to claim 17, characterized in that the component of the vehicle is chosen from a group consisting of a transmission, a fuel pump, an ignition coil, an ignition switch, a starter, a battery, an on-board computer, a fuel line and a fresh air supply conduit of the motor.

20. A method according to claim 17, characterized in that it further comprises:
generating a signal when sensing motion of the vehicle; and
sending the generated signal to the control unit (20).

21. A method according to claim 20, characterized in that sending the generated signal to the control unit (20) is made using a RF transmitter (44).

22. A method according to claim 17, characterized in that it further comprises reporting an alarm event.

23. A method according to claim 22, characterized in that reporting an alarm event comprises establishing communication with a remote monitoring central.

24. A method according to claim 23, characterized in that it further comprises sensing the position of the vehicle and transmitting it to the remote monitoring central (100).

25. A method according to claim 24, characterized in that sensing the position of the vehicle comprises reading data signal from a global positioning system (GPS) receiver.

26. A method according to claim 24, characterized in that transmitting the position of the vehicle is made using a RF emitter.

27. A method according to claim 26, characterized in that the RF emitter comprises a cellular phone.

28. A method according to claim 17, characterized in that it further comprises providing at least one decoy unit (60) in the vehicle.
